(19) United States
(12) Patent Application Publication
(10) Pub. No.: US 2011/0059746 A1
(43) Pub. Date: Mar. 10, 2011

(54) Method And Apparatus For Managing Versions Of Various Application Information Messages And Using The Application Information Messages

(75) Inventors: Young In Kim, Seoul (KR); Ho Taek Hong, Seoul (KR)

(73) Assignee: LG ELECTRONICS INC., Seoul (KR)

(21) Appl. No.: 12/517,835

(22) PCT Filed: Jul. 31, 2007
(86) PCT No.: PCT/KR2007/003678

§ 371 Date: Nov. 22, 2010

Related U.S. Application Data
(60) Provisional application No. 60/869,184, filed on Dec. 8, 2006.

(51) Int. Cl. H04W 64/00

(52) U.S. Cl. 455/456.1

(57) ABSTRACT

The present invention manages components carrying application information thru their individual versions. An application information encoding method according to the present invention comprises creating at least one component including application information and version information of the at least one component; writing, in a message management container where management information on the at least one component is written, information indicating that the version information is accompanied; and organizing the at least one component, the version information and the message management container to a transfer message

### 1. TECHNICAL FIELD

The present invention is related to a method and apparatus for providing messages carrying a variety of application information needed for operation of public transportation means or vehicles and using the provided information.

### 2. BACKGROUND ART

As various car navigation devices and portable wireless terminals for personal use are widely spread, traffic information guide is becoming a major topic for car drivers. A current navigation device (or a portable wireless terminal for personal use) provides drivers (or individuals) with application services such as route guidance for vehicle operation based on a map and GPS system. In ordinary circumstances, such services are provided based on a map embedded in a receiving device, local information and coordinate information received from GPS.

Being in such a situation, TPEG (Transport Protocol Experts Group) technology gaining much attention recently provides a basic framework whereby various services for individual local areas including traffic conditions, traffic accidents, parking information, local information (spatial information about structures located at fixed positions such as restaurants, buildings, and public facilities or spaces) and public transportation information are provided through various media channels (e.g., TV or radio broadcast channel).

A specific application service based on TPEG technology comprises transmitting TPEG-messages having a structure illustrated in FIG. 1 to a terminal and the terminal's interpreting the TPEG-messages, thereby providing an information service for the user. The

TPEG message of FIG. 1 selectively includes a message management container 10A carrying version information for managing TPEG messages, an application status container 10B carrying application information distinguished for individual application services, and a TPEG location container 10C carrying information about location where a service is provided.

Various application services that can be provided by utilizing TPEG technology include TPEG-SNI (Service and Network Information), TPEG-RTM (Road Traffic Message), and TPEG-CTT (Congestion and Travel-Time). The services are all transmitted through TPEG message structure of FIG. 1 and specific application information is carried by the application status container 10B.

Meanwhile, the message management container 10A (hereinafter, it is called ‘MMC’ for short) transfers management information about the corresponding TPEG message having the structure shown in FIG. 2.

The MMC structure of FIG. 2 illustrates that of a TPEG-RTM service among application services based on TPEG. MMCs for other application services also have a message identifier (Message ID), a version number for managing information update, length, and a selector as necessary items. The message ID is used to distinguish each individual TPEG message and the version number is used to keep each message up-to-date. length provides the length of the total message to show the size of valid data and the selector is used to transfer necessary information in accordance with the corresponding message. Up to eight fields are employed, each of which is associated with the corresponding bit of the select. In the example of FIG. 2, these fields include start time, stop time, and message expiry time, which are varied according to type of an application service utilizing TPEG technology. TPEG components, the last field of the selector (a field accompanying when the most significant bit of the selector is 1), comprises components carrying a plurality of service information and thus constitutes the application status container 10B mentioned above, each component including data used for an actual service.

While application information is provided using the above structure, transfer of information is carried out in the form of the same structure at each time of transfer. Therefore, when part of application information provided for a terminal is changed (or when new information is added), for example when part of local information is changed, a TPEG message including not only a component or components carrying the changed contents but also components carrying the contents of unchanged local information is organized and transmitted. At this time, a value higher than the version number included in MMC of a previously transmitted TPEG message is assigned to the version number of MMC (for example, if previous transmitted version number is “1.0.0.”, “1.0.1” is assigned and transmitted). This implies that updated information is present in the information transmitted by a TPEG message of the corresponding application service transferred previously.

Accordingly, when the terminal receives a TPEG message having a higher value than the version number of a previously received TPEG message, the terminal decodes all the information accompanying the message and updates previously decoded information and displays the information for the user in case of need.

Although only part of the information transmitted by a TPEG message has been updated, since the above method, based on a version number of MMC higher than a previous one, decodes all the received components and regards, stores, and uses the decoded components as updated information, resources (such as computing power, etc) more than needed are wasted to obtain actually updated information.

### 3. DISCLOSURE OF THE INVENTION

One objective of the present invention is to provide application service information for a terminal to effectively obtain updated information.

Another objective of the present invention is to enable much more amount of diverse application service information to be provided more quickly within limited resources of communications.

One method for encoding application information according to the present invention comprises creating at least one component including application information and version information of the at least one component, writing, in a message management container where management information about the at least one component is written, information indicating accompaniment of the version information, and organizing the at least one component, the version information and the message management container to a transfer message.

One method for decoding application information according to the present invention comprises extracting from received signals a transfer message including at least one component carrying application information, checking a selector indicating accompaniment of information recorded in a message management container in the extracted transfer message, and extracting identifying information and version information for identifying the at least one component from the transfer message according to the checked value of the selector.

In one embodiment according to the present invention, the version information is created with a one-to-one correspondence to identifying information of a component and is included in the message management container.

In one embodiment according to the present invention, information for identifying a component is an ID assigned to a component, classified according to type of information carried by the component.

In one embodiment according to the present invention, the version information and identifying information of a component are recorded put together at a component management information unit within the message management container.

In the one embodiment, the component management information unit further includes information about information type and information about the number of components.

In one embodiment according to the present invention, the information about information type is used to indicate whether all or only part of at least one component belonging to a transfer message includes updated information.

In one embodiment according to the present invention, when deletion of information transferred by a component included in the above transfer message is requested, the version information is assigned a particular value and thus transferred.

In one embodiment according to the present invention, one bit value of the selector included in the message management container indicates whether version information about the at least one component is included.

In one embodiment according to the present invention, another bit of the selector is used to indicate whether information about time including creation and/or expiry time of the at least one component accompanies.

In one embodiment according to the present invention, yet another bit of the selector is used to indicate whether management information distinguished according to application services is included put together in the message management container.

In one embodiment according to the present invention, the application information is information needed for vehicle operation, service information of a public transportation means or information about a local area.

### 4. BRIEF DESCRIPTION OF THE DRAWINGS

FIG. 1 illustrates an organizing format of a message transferred to a terminal for an application information service;

FIG. 2 illustrates one example of information composition syntax of a message management container of FIG. 1 with respect to a particular application service;

FIG. 3 illustrates a network where an information service is provided as version of application service information is managed according to the present invention;

FIG. 4 illustrates information composition syntax of a message management container organized by an application information providing server of FIG. 3 according to one embodiment of the present invention;

FIGS. 5A through 5C respectively illustrate syntax of primary information elements of a message management container of FIG. 4 according to the embodiments of the present invention;

FIG. 6 illustrates a structure of a component management information unit organized and transferred by an application information providing server of FIG. 3 according to the syntax illustrated in FIG. 5B;

FIG. 7 illustrates an organizing format of a TPEG message centering round a component management information unit transferred to a terminal according to one embodiment of the present invention;

FIG. 8A illustrates an organizing format of a TPEG message including updated information centering round a component management information unit according to one embodiment of the present invention;

FIG. 8B illustrates an organizing formation of a TPEG message including updated information centering round a component management information unit according to one embodiment of the present invention;

FIG. 8C illustrates a component management information unit including a command for requesting deletion of information of a transferred component according to one embodiment of the present invention;

FIG. 9 illustrates a structure of a terminal receiving signals of an application information service according to one embodiment of the present invention; and

FIG. 10 illustrates a table built for the terminal of FIG. 9 to manage received version information according to one embodiment of the present invention.

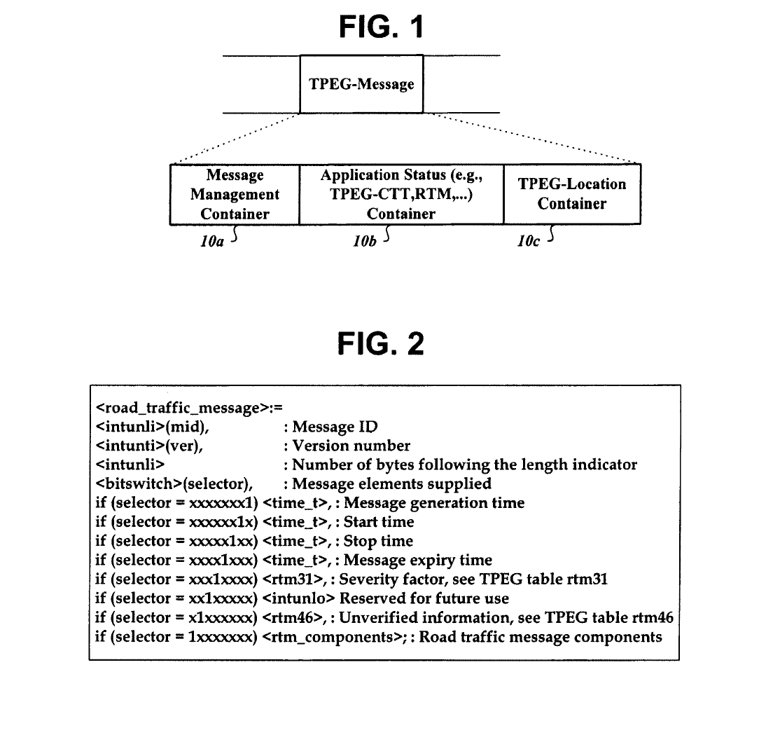

### 5. BEST MODE FOR CARRYING OUT THE INVENTION

Hereinafter, according to the present invention, preferred embodiments will be described in detail with reference to appended drawings.

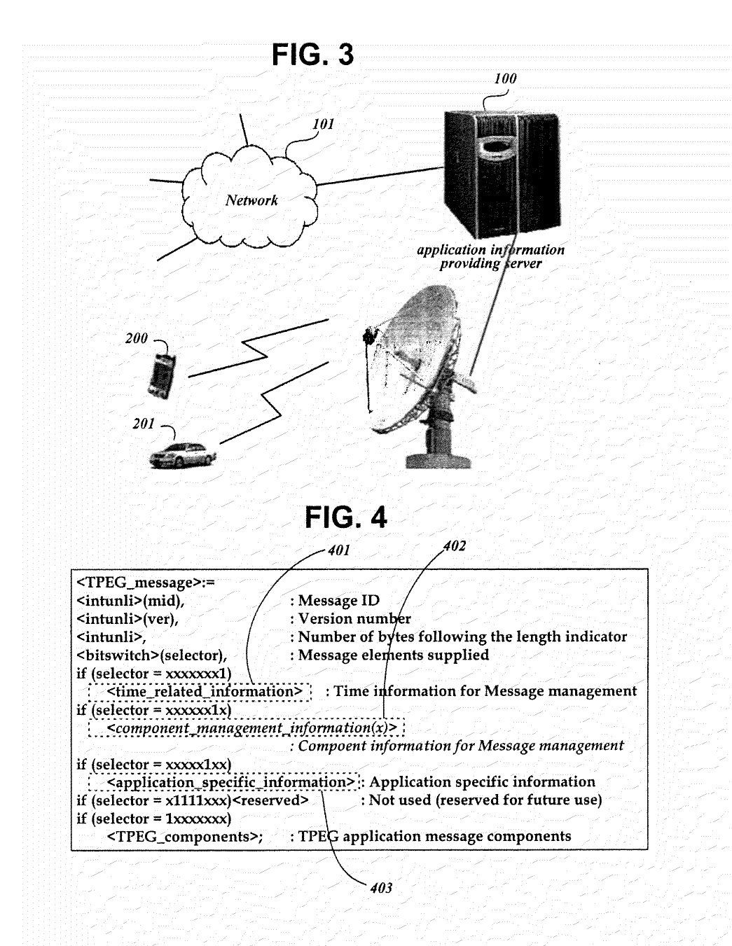

FIG. 3 illustrates a network where version of application service information is managed so that information services are provided. In the network of FIG. 3, an application information providing server 100 in a broadcast station classifies and organizes information about congestion and road conditions (e.g., obstacles on the road) collected from various sources (e.g., operator input, information received from another server through a network 101 or probe cars), parking information and public transportation information with respect to each individual application information and transmits the organized information wirelessly so that a navigation terminal installed in a car 201 or an information terminal 200 carried by the user can receive the information. An information originator organizing a variety of application information and a carrier transmitting the organized information wirelessly can be different service providers.

The application information providing server 100 can also provide a variety of other application information (e.g., weather and local information associated with traffic) in addition to previously illustrated application information. Alternatively, the application information providing server 100 provides only congestion and travel-time (CTT) information while other application information is provided through a different server.

The MMC of a TPEG message carrying application information organized and transferred by the application information providing server 100 or the different server is written according to the structure illustrated in FIG. 4. The MMC structure of FIG. 4 has a selector whose bits have the corresponding accompanying fields different from those of FIG. 2.

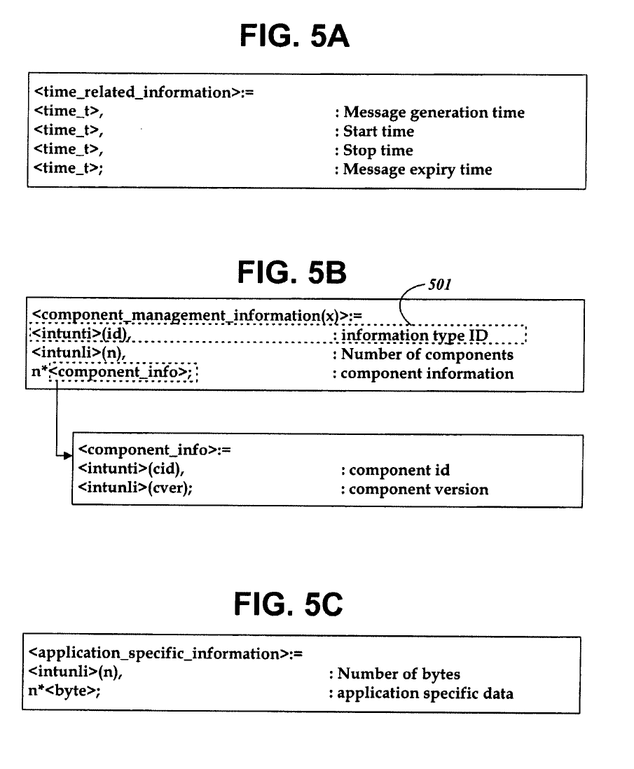

To describe the MMC structure of FIG. 4 specifically, the least significant bit (b0) of a selector indicates accompaniment of a time-related information unit (<time_related_information>) 401 integrating time information for message management organized according to the syntax illustrated in FIG. 5A. The next significant bit (b1) indicates accompaniment of a specific information unit (<application_specific_information>) 203 organized according to the syntax of FIG. 5C with respect to characteristics of an individual application service, being provided independently of subsequent components.

As the application information providing server 100 organizes MMC of a TPEG message for each individual application service as shown in FIG. 4, redundancy occurs in the bits of a selector as compared with a method of FIG. 2. Therefore, by assigning more information needed for message management and relating the information with specific redundant bits, a possibility for much effective management of messages is left open.

The time-related information unit illustrated in FIG. 5A is an example defined with respect to a TPEG-RTM service; in case of a different application service, internal elements defined can be somewhat different from those of FIG. 5A. However, irrespective of type of an application service based on TPEG, one single bit is used for a field indicating accompaniment of information related with time of a TPEG message such as creation, expiry or valid time of a TPEG message. In one embodiment according to the present invention, time-related information, too, is recorded put together in a single field within MMC as shown in FIG. 5A according to the value of a bit (b0) of a selector instead of being added individually as shown in FIG. 2 according to the value of each bit of a selector within MMC.

The foregoing description applies equally to the case of a specific information unit of FIG. 5C. That is to say, specific information provided separately from a component, the information being varied according to each individual application service, is recorded put together in a single field within MMC as shown in FIG. 5C according to the value of a bit (b2) of a selector instead of being added individually according to respective bits of a selector as shown in FIG. 2.

In one embodiment according to the present invention, actual data according to an individual application service, namely a component management information unit organized according to the syntax illustrated in FIG. 5B, including version information about individual components carrying application data, is included in an MMC and provided. At this point, a specific bit of a selector, for example b1 is set as illustrated in FIG. 4.

A component management information unit of FIG. 5B includes an information type identifier (ID) indicating type of information carried by the unit and more than one component information unit including version information assigned in correspondence to a component ID.

The information type ID 501 indicates whether a component or components following MMC within a TPEG message carry only updated information. For example, if the information type ID 501 is 1, it indicates that a subsequent component or components carry information composing entirely of updated application information whereas it indicates subsequent components carry the same information as transferred previously in addition to updated information if the information type ID 501 is 0. A specific example of the above is described in detail below.

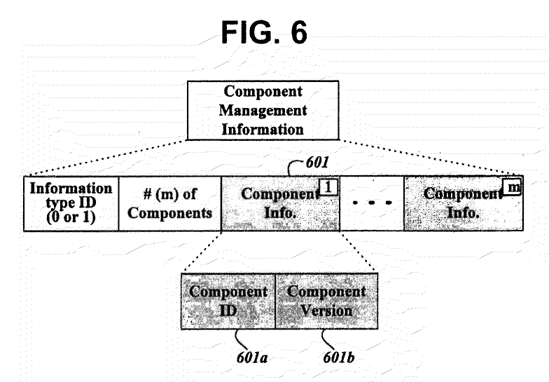

FIG. 6 illustrates a structure of a component management information unit organized and transferred by the application information providing server 100 according to the syntax illustrated in FIG. 5B. As shown in the figure, each component information unit 601 includes information about a component ID 601A and a component version 601B. The component ID unit 601A records an ID identifying a particular component or a component carrying specific type of information. The component carrying specific type of information can be a component carrying local information, a component carrying average speed information about a road segment, or a component carrying location information of a station for a public transportation means. As a matter of course, in addition to the above, the component ID unit 601A is used to identify a component carrying information belonging to a certain type of information among various types of application information provided from an application service. Version information carried by the version unit 601B represents a version of application information transferred being carried by a component or components specified by the component ID 601A.

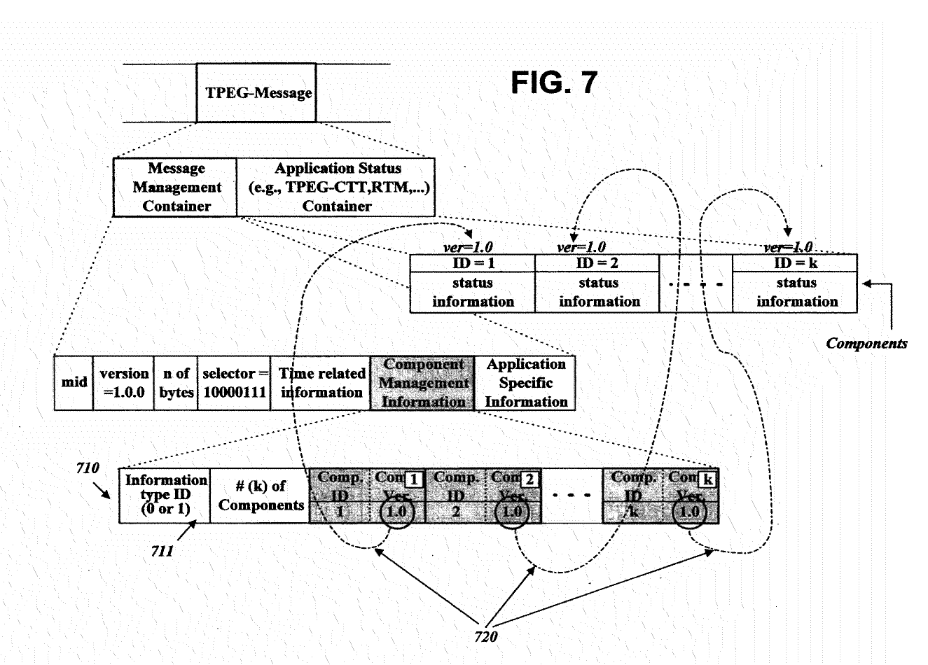

Therefore, the application information providing server 100, to organize an initial TPEG message for an arbitrary application service, assigns a version to each component carrying application data included in the TPEG message and loads information about the assigned version to the component management information unit and transfers the information. FIG. 7 illustrates a TPEG message transferred according to the above with respect to a component management information unit.

In the example of FIG. 7, in case of transfer of an initial TPEG message in the corresponding application service, information carried by individual components accompanying MMC should be considered as the latest information by a terminal. Therefore, information type ID 711 in a component management information unit 710 transferred to assign a version to each component is also assigned a value (e.g., 1) to indicate that all the components in a TPEG message carry the latest information. It is obvious, however that in case of transfer of an initial TPEG message, since an information receiving terminal does not keep the version of a previously received component, irrespective of an actual version of a component, the component would be regarded to be of the latest version. Therefore, for the case of transfer of an initial TPEG message, the information type ID 711 can be assigned a value (e.g., 0) indicating that only part of the TPEG message carries the latest information.

In the example of FIG. 7, each component information unit in the component management information unit 710 includes information for assigning a version to each ID of components transferred being carried by an application status container subsequent to MMC 720. Although the example of FIG. 7 assumes one-to-one correspondence between components and component IDs for intuitive understanding, it is obvious that one ID can correspond to multiple components for providing actual application services. This is because a component ID is used to designate a component carrying a specific type of application information (e.g. section average speed, section travel time, service route information of an arrival bus for each bus stop) and a specific type of information can be transferred being divided into several components. The above description applies in the same manner to the following description.

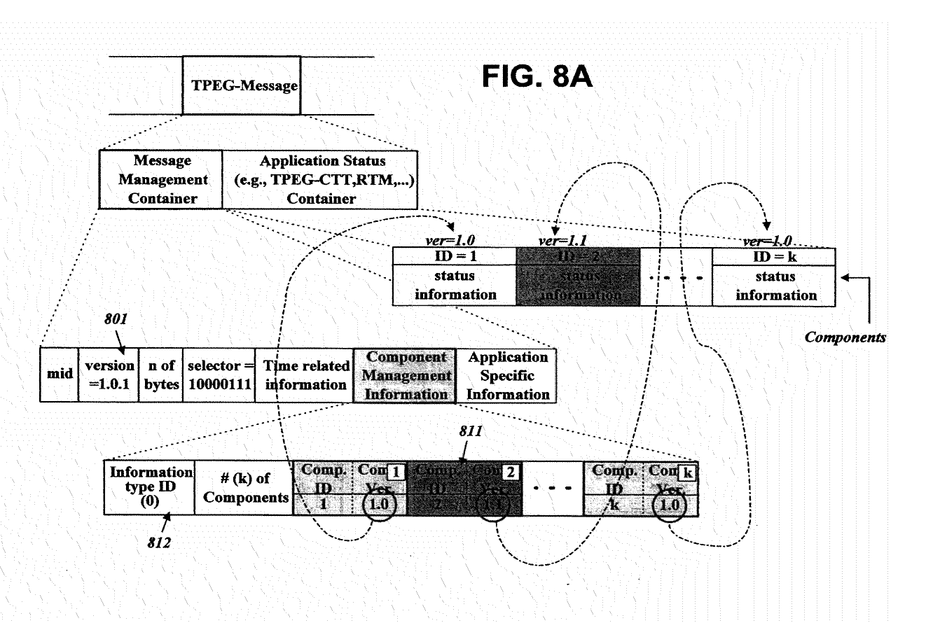

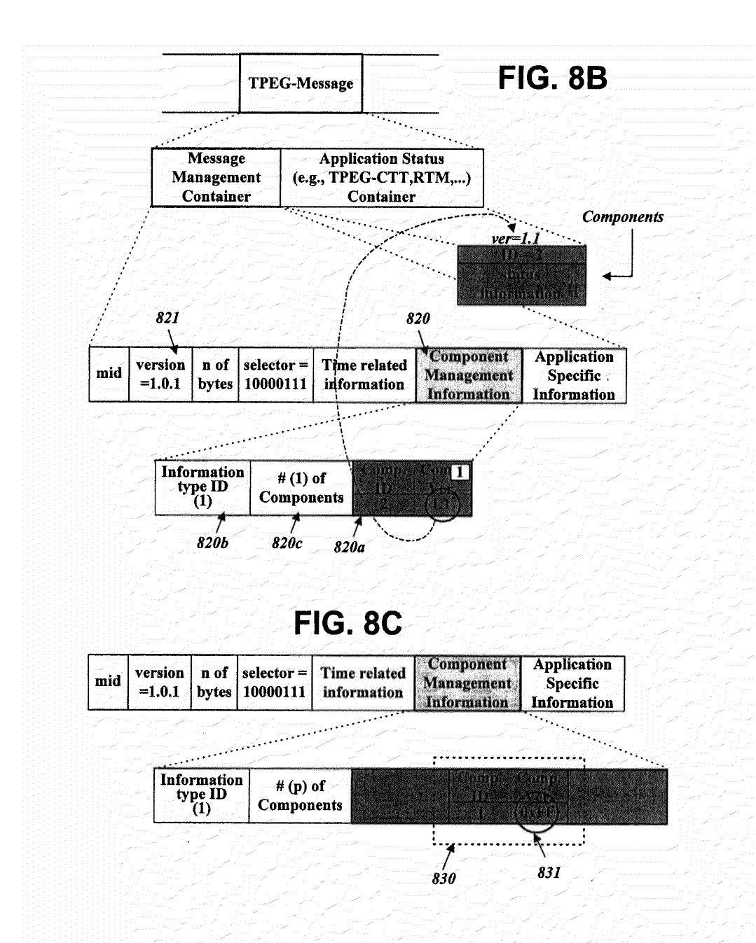

After transfer of an initial TPEG message as illustrated in FIG. 7, if changes occur in the contents of information carried by components constituting part of the TPEG message (e.g., part of local information, road congestion information, road obstacle information, or public transportation information) or if new information has to be provided by a component to which a new ID has been assigned, as shown in FIG. 8A, the application information providing server 100, with respect to a component carrying changed information (or new information), e.g., a component with an ID 2, loads MMC with a component management information unit including a component information unit 811 having a higher version than a previously assigned version “1.0” (e.g., “1.1”) and thus transfers the component. At this point, version information in MMC 801 can also be transferred with a higher value (e.g., “1.0.1”) than that of a previously transferred TPEG message. This is intended for a terminal to know the existence of updated information (or new information) in the information carried by a received TPEG message without decoding a component management information unit. In another embodiment according to the present invention, a terminal always decodes a component management information unit and if part of components included in a TPEG message includes changed information, the same version as MMC version of a previous TPEG message is used.

As illustrated in FIG. 8A, in an embodiment wherein a component including updated information is provided, since only part of components in a TPEG message being transferred includes updated information, to notify of the above, the application information providing server 100 records a value of 0 in information type ID 812 within a component management information unit.

In another embodiment according to the present invention, only such a component including updated or new information is included in a TPEG message and thus transferred. FIG. 8B illustrates an example of a message organized and transferred by the application information providing server 100 according to the present invention. As shown in FIG. 8A, if only the contents of information carried by part of components in a previously transferred TPEG message (namely, a component of an ID 2) have been changed from those of a previous TPEG message (or if a component including new information has to be provided by assigning a new ID (e.g., “k+1”) to the component), the component including changed information (or new information) is transferred being included in a status container as shown in FIG. 8B and at the same time, only a component information unit of ID 2 820A is included in a component management information unit 820. At this time, a version assigned to the component information unit 820A has a higher value (e.g., “1.1”) than that assigned earlier to the corresponding component. Also, since a TPEG message and the component management information unit 820 being transferred include only such a component carrying changed or new information and version information about the component respectively, a value of ‘1’ is recorded for information type ID 820B within the component management information unit 820 to indicate the above and thus transferred.

Since the entire contents of a TPEG message being transferred carry changed or new information with respect to a previously transferred TPEG message, the application information providing server 100 assigns a version value to a version field of a message management container 821, e.g., “1.0.1” higher than that transferred previously.

Since provision of application information according to the present embodiment makes data size small on the average, a high transfer frequency can be implemented within limited transmission bandwidth. This immediately enables the user who uses the corresponding application service to obtain the latest information more quickly.

In the embodiments according to the present invention, in order for a terminal not to use information provided by a previously transmitted component, a command for requesting deletion of a component with the corresponding ID can be transferred through a component management information unit. For example, if information provided by an arbitrary component among components provided through a TPEG message becomes unnecessary information after particular time (e.g., midnight) or termination of a particular accident (e.g., removal of road blockage), it is necessary to delete information provided through the component after the particular time or termination of the particular accident. In this case, the application information providing server 100, as shown in FIG. 8C, loads ID (j in FIG. 8C) assigned to a component carrying the information to be deleted and a component information unit carrying in a version field 831 an invalid value for a version (e.g., 0xFF) into the component management information unit and transfers the above. At this point, a component with the corresponding ID is not contained in a subsequent status container.

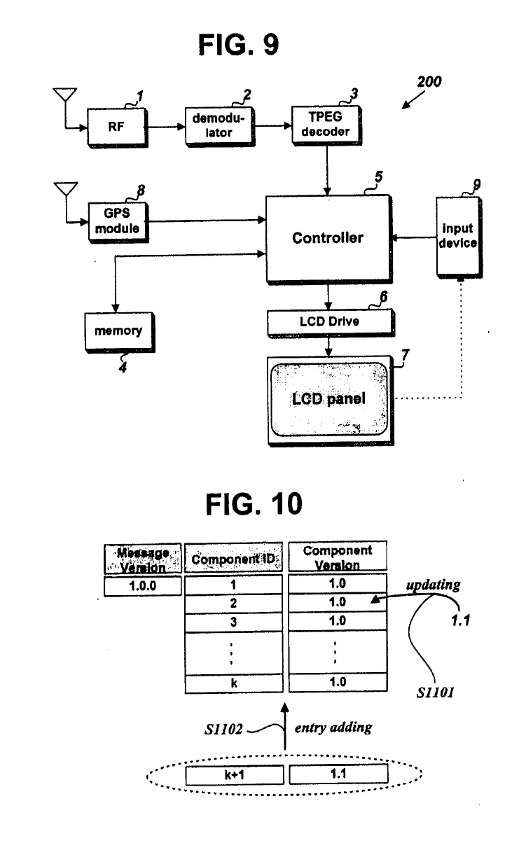

FIG. 9 illustrates a structure of a terminal according to one embodiment of the present invention, receiving application information (this application information is either one of a variety of application information such as road congestion information, road obstacle information and service status information of a public transportation means or combination thereof) organized and transferred by the application information providing server 100 according to a method described with reference to FIGS. 4, 5A through 5C, 6, 7, and/or 8A through 8C, the terminal carried by a person or installed in a car.

The terminal (200 or a navigation device installed in a car 201) of FIG. 9 comprises a tuner 1 resonating at the required frequency band of a specified application information service and subsequently outputting modulated application information signals, a demodulator 2 outputting application service signals by demodulating the modulated application information signals in an appropriate manner, a TPEG decoder 3 decoding the demodulated application service information signals and acquiring application information, a GPS module 8 for calculating a current position (i.e., latitude, longitude, and altitude) by receiving signals from a plurality of satellites, memory 4 pre-storing a variety of graphic information and temporarily storing necessary information, an input device 9 receiving the user's input, a controller 5 controlling screen display based on the user's input, current location, and acquired application information, an LCD panel 7 for video display and an LCD drive 6 feeding driving signals to the LCD panel 7 according to graphic data for display. The input device 9 can be a touch screen equipped on the LCD panel 7. The terminal (200 or a navigation device installed in a car 201) can be further equipped with non-volatile memory containing an electronic map in addition to the memory 4.

The tuner 1 resonates at signals that the application information providing server 100 (or a carrier that receives and transmits application information organized by the application information providing server 100) transmits; the demodulator 2 demodulates and outputs resonating signals in a manner specified by the controller 5. The TPEG decoder 3 then decodes application information provided by input demodulated signals and delivers the decoded information to the controller 5.

The TPEG decoder 3 extracts a TPEG message from demodulated signals from the decoding process and checks MMC organized as in FIG. 4 first. If a version field (ver) of the MMC has a value lower than that previously decoded and stored to the TPEG decoder 3, a status container including subsequent components is not decoded but ignored.

Since it indicates reception of an initial TPEG message when no version information is found to be stored in the TPEG decoder 3, a value of a version field (ver) within a message management container identified at this time is stored in the TPEG decoder 3; the TPEG decoder 3 then checks ID and version information about each component carried by a component management information unit within the container, thereby storing the ID and version information in a form of a table by associating each other as a pair as shown in FIG. 10. Surely, at this point, subsequent components are all decoded and information acquired from the decoding is transferred to the controller 5.

Unless the value of a version field (ver) within MMC is lower than that previously decoded and stored in the TPEG decoder 3, information carried by a component management information unit organized as shown in FIG. 6 within the MMC is investigated and it is determined whether to decode a component or part of subsequent components. If a received TPEG message is organized as shown in FIG. 8A and information type ID in a component management information unit is indicating that updated information is present only in some part of subsequent components (e.g., if information type ID is 0), the TPEG decoder 3 compares ID and a version value carried by each individual component information unit within the component management information unit with a version value stored in association with the same ID in the table constructed as shown in FIG. 10. If a received version value is higher than a stored value or if an ID identical to a received component ID is not stored already in the table constructed as shown in FIG. 10, the TPEG decoder 3 decodes among subsequent components only such a component that has the corresponding ID with a high version value (or a new ID received for the first time) and transfers application information contained in the component to the controller 5.

Therefore, when a version is not provided with respect to each component ID, as the TPEG decoder 3 decodes all the received components and delivers the decoded components to the controller 5, thereby overwriting previously stored information, operations leading to waste of computing power are prevented. For the case of decoding with respect to some component ID as above, a version value higher (e.g., “1.1”) than a previous value received in accordance with the ID is either recorded by updating the corresponding version field S1101 or added to a table constructed as shown in FIG. 10 by associating the ID with the received version value as a single entry.

If a received TPEG message is organized as shown in FIG. 8B and information type ID within a component management information unit is indicating that subsequent components all include updated information (e.g., if information type ID is 1), all the subsequent components (as many components as the number recorded in a number of components field 820C of a component management information unit of FIG. 8B) are decoded and application information acquired from the above is provided for the controller 5. Also, the TPEG decoder 3 updates a version value of each component information unit within the component management information unit and records the value in a version field within the table of FIG. 10 corresponding to the same ID. As a matter of course, before decoding and updating a version field as described above, whether a version value carried by each component information unit is higher than that stored in a pair with the ID identical to the corresponding ID of the version value can be checked. Unless the version value is found high, decoding and updating a version value as described above are not carried out, which is intended to avoid fault in organizing information from the application information providing server 100.

The controller 5, from decoded application information received from the TPEG decoder 3, constructs an application information table in the memory 4 in a form appropriate to provide for the user. At this time, constructed application information also contains the ID of a component that carried the information, the ID being delivered from the TPEG decoder 3.

If the user requests specific information, e.g., ‘public transportation information’ from the application information constructed in the memory 4, through the input device 9, the controller 5 displays a menu related to public transportation information on the LCD panel 7. At this point, a menu screen can be organized based on position information obtained from the GPS module 8. With regard to stations, for example, a list consisting of only those stations close to a current position can be prepared and provided as a station selection window.

If the user enters additional information, e.g., a service route number (or a station), from a menu displayed on the LCD panel 7 through a relevant UI, the controller 5 searches the memory 4 and obtains information about each station (or each transit service route) constructed in the memory 4 and displays station names (or ID of each transit service route and service route information) on a screen together with a service route ID and service route information. At this time, if different type of information is associated with a table constructed in the memory 4, the information can also be provided together.

Selection of public transportation information and contents of information provided by the controller 5 according to the selection are nothing but a simple example. Contents of the above information carried by each component are not necessarily required for the present invention and management of a version for each individual component as described above and operations according thereto can be applied immediately by following instructions described above independent of application information being loaded into a component. Therefore, a case where the contents of application information carried by a component are different from those illustrated to help understanding the present invention should also be considered to belong to the scope suggested in the principles and purpose of the present invention.

While receiving and storing the information described above and information display according to a request of the user are being carried out, if a component information unit, being organized as illustrated in FIG. 8C and demanding deletion of information provided by a component of a particular ID, is received being included within MMC, the TPEG decoder 3 interprets a command for deleting a version field, processes remaining information except for a component information unit 830 including the deletion command according to the procedure described above and extracts a component ID recorded in the component information unit 830, thereby providing an internal command for requesting information deletion for the controller 5 along with the extracted ID. The controller 5 then carries out an operation of deleting application information stored in association with a received ID from among an application information table constructed and managed by the controller 5. Since the deletion operation invokes an operation for de-allocating an area of the memory 4 where the corresponding information has been stored, the released area can be used again for another received information.

The present invention described in detail through a limited number of embodiments above, when update of application information or transfer of new application information through a new component is requested frequently, enables to transfer only the corresponding application information, thereby achieving effective utilization of limited transfer resources and also enables a terminal to selectively decode only those data having updated or newly added application information, thereby achieving effective utilization of resources of the terminal and prompt processing of information.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

1. A method for encoding application information, comprising:
creating at least one component including application information, and version information of the at least one component;
writing, in a message management container where management information about the at least one component is written, information indicating that the version information is accompanied; and
organizing a transfer message including the at least one component, the version information and the message management container.

2. The method of claim 1, wherein the creating further includes, in addition to version information about the at least one component, creating information for identifying a component to which the version information is assigned.

3. The method of claim 2, wherein the information for identifying a component is an ID that is assigned to a component, classified according to type of information carried by a component.

4. The method of claim 1, wherein the creating further creates information about information type.

5. The method of claim 4, wherein the information about information type is used to indicate whether all or only part of the at least one component belonging to the transfer message includes updated information.

6. The method of claim 1, wherein the creating further creates information about number of the at least one component.

7. The method of claim 1, wherein a particular value is assigned to the version information in case of requesting to delete information transferred by a component included in a previously transferred transfer message.

8. The method of claim 1, wherein the creating further creates information about time including creation and/or expiry time of the at least one component, and the writing further writes information indicating accompaniment of the information about time in a message management container in which management information about the at least one component is written.

9. The method of claim 8, wherein the information indicating accompaniment of the version information and the information indicating accompaniment of the information about time are composed of one bit, respectively.

10. The method of claim 1, wherein the application information includes information needed for vehicle operation, service information of public transportation means, and/or information about a local area.

11. A method for decoding application information, comprising:
extracting from received signals a transfer message including at least one component carrying application information;
checking a selector indicating whether information is accompanied, the selector being recorded in a message management container within the extracted transfer message; and
extracting identifying information and version information of the at least one component from the transfer message based on a value of the checked selector.

12. The method of claim 11, wherein the identifying information is an ID that is assigned to a component, classified according to type of information carried by a component.

13. The method of claim 11, further comprising decoding all or part of components included in the transfer message based on the extracted version information.

14. The method of claim 11, wherein the extracting identifying information and version information further extracts information about information type from the transfer message.

15. The method of claim 14, further comprising,
determining based on the information about information type whether all or only part of the at least one component includes updated information.

16. The method of claim 15, further comprising decoding from among the at least one component a component identified by identifying information indicating that the extracted version information is higher than a previous version, if the information about information type indicates that only part of the at least one component includes updated information.

17. The method of claim 15, further comprising,
decoding all of the at least one component if the information about information type indicates that all of the at least one component includes updated information.

18. The method of claim 16, further comprising,
as for version information of the component included in the extracted version information, replacing already-stored corresponding version information with the version information of the component.

19. The method of claim 11, further comprising,
if the extracted version information is a particular value requesting deletion of information transferred by a component included in a previously received transfer message, deleting stored application information obtained from a component identified by identifying information received in a pair with the particular value and releasing an occupied space by the stored application information.

20. The method of claim 11, wherein the extracting identifying information and version information includes extracting, if value of a single bit of the selector indicates that identifying information and version information of a component is carried in the transfer message, identifying information and version information of the at least one component from the transfer message.

21. The method of claim 20, wherein the selector further indicates by using a single bit that information about time including creation and/or expiry time about the at least one component is carried in the transfer message.

22. The method of claim 11, wherein the application information includes information needed for vehicle operation, service information of public transportation means, and/or information about a local area.

23. An apparatus for receiving application information, comprising:
a demodulator configured to demodulate received signals;
a decoder configured to extract a transfer message including at least one component from the demodulated signals and to extract, based on value of a selector indicating whether information is accompanied, identifying information and version information of the at least one component from the transfer message, the selector being recorded in a message management container within the extracted transfer message, and to selectively decode the at least one component based on the extracted identifying information and version information; and
a controller configured to store the extracted identifying information and version information and to store and/or output through an output unit application information obtained from a component decoded by the decoder.

24. The apparatus of claim 23, wherein the identifying information is an ID that is assigned to a component, classified according to type of information carried by a component.

25. The apparatus of claim 23, wherein the decoder is configured to decode all or part of components included in the transfer message, identified by identifying information indicating that the extracted version information is higher than a previous version.

26. The apparatus of claim 25, wherein the decoder is configured to replace, as for version information of the component included in the extracted version information, already-stored corresponding version information with the version information of the component.

27. The apparatus of claim 23, wherein the controller is configured to delete, if the extracted version information is a particular value requesting deletion of information transferred by a component included in a previously received transfer message, stored application information obtained from a component identified by identifying information received in a pair with the particular value and to release the occupied space by the stored application information.

28. The apparatus of claim 23, further comprising,
a position detector configured to obtain information on a current location, wherein the controller is configured to select, based on the obtained information on current location, part of the obtained application information and output the selected part through the output unit.

29. The method of claim 17, further comprising,
as for version information of the component included in the extracted version information, replacing already-stored corresponding version information with the version information of the component.
